(19) United States
(12) Patent Application Publication
(10) Pub. No.: US 2022/0147358 A1
(43) Pub. Date: May 12, 2022

(54) GENERATION OF HIGHER-RESOLUTION DATASETS WITH A QUANTUM COMPUTER

(71) Applicant: Zapata Computing, Inc., Boston, MA (US)

(72) Inventors: Alejandro Perdomo Ortiz, Toronto (CA); Manuel S. Rudolph, Heidelberg (DE)

(21) Appl. No.: 17/525,078

(22) Filed: Nov. 12, 2021

Related U.S. Application Data
(60) Provisional application No. 63/112,485, filed on Nov. 11, 2020.

(51) Int. Cl. G06F 9/38; G06N 10/00; G06N 20/00

(52) U.S. Cl. CPC G06F 9/38; G06N 20/00; G06N 10/00

(57) ABSTRACT

A system and method for generating higher-resolution datasets including handwritten numerical digits, color images, and video using generative adversarial networks (GANs) and quantum computing methods and components. A GAN includes a generator and discriminator and a quantum component, which provides input to the generator and accepts a sequence of instructions to evolve a quantum state based on a series of quantum gates to generate a higher resolution dataset. The quantum component may be in the form of quantum computer born machine (QCBM), implemented using a quantum computing associating adversarial network (QC-AAN) model using a multi-basis technique. The quantum computer elements may be implemented as a trapped-ion quantum device and use at least 8-qubits.

### FIELD OF INVENTION

The disclosed technology is directed to a system and method for generating higher resolution datasets including handwritten numerical digits, monochrome and color images, and video using generative adversarial networks and quantum computing components and methods.

### BACKGROUND

The subject matter discussed in this section should not be assumed to be prior art merely as a result of its mention in this section. Similarly, any problems or shortcomings mentioned in this section or associated with the subject matter provided as background should not be assumed to have been previously recognized in the prior art. The subject matter in this section merely represents different approaches, which in and of themselves can also correspond to implementations of the claimed technology.

Generative adversarial networks (GANs) make it possible to create realistic datasets, which are indistinguishable from true data. GANs are being used in various applications such as image processing. One application of GANs is the generation of higher-resolution handwritten digits, which simulate actual handwritten digits. The method generally includes training a GAN with supervised machine learning (ML) algorithms using training data from various sources.

One known training data source is the MNIST (Modified National Institute of Standards and Technology) database, which is a collection of thousands of handwritten digits that are used for training ML algorithms for supervised and also unsupervised deep learning applications.

GANs most commonly consist of a generator coupled with a discriminator forming two competing neural networks. A GAN is often compared to a game between the two neural networks. Instances of real data, images for example, are input to the discriminator along with instances of synthesized or fake data, provided by the generator. The discriminator attempts to classify each instance as “real” or “fake” and the discriminator and generator are updated accordingly, in turn. Both networks continue to improve over time until the generator produces exceedingly convincing samples which fool the discriminator.

This ideal functionality of a GAN is known in the art. A database of training data supplies real data instances to the discriminator. Synthetic or fake data generated by the generator are also provided to the discriminator. The generator is fed random noise to produce a set of fake data points supplied to the discriminator. The discriminator classifies the data from the two sources as real or fake. The GAN then calculates its loss with respect to how probable (or confident) the discriminator was in classifying the generated data as real.

There is a need to improve known GAN architectures by eliminating the randomized data requirement in the generation of higher-resolution datasets. The disclosed technology overcomes the drawbacks of prior methods of generating higher-quality handwritten digits.

### SUMMARY

The disclosed technology is a quantum-assisted machine learning framework, which includes a quantum-circuit based generative model to learn and sample the prior distribution of a GAN. The disclosed technology overcomes the drawbacks of prior methods of generating higher quality handwritten digits and has widespread applications including image processing. Using quantum computers in such tasks enhances the accuracy of conventional machine learning algorithms. The present invention also addresses conventional quantum circuit challenges which limit the number of qubits because of factors such as gate noise in available devices. The disclosed technology provides a method and implementation of a quantum-classical generative algorithm capable of generating higher-resolution images of handwritten digits, monochrome and color images, and video frames, with near-term gate-based quantum computers.

In one aspect, the disclosed technology uses a generative adversarial network (GAN) trained on the popular MNIST dataset for handwritten digits. The MNIST database (Modified National Institute of Standards and Technology), which is merely one example of a dataset on which the disclosed technology may be trained, is a comprehensive database of handwritten digits commonly used for training and testing image processing systems in machine learning applications. In one embodiment, quantum computer elements are used to enhance conventional machine learning algorithms to produce higher-resolution datasets, which may represent handwritten digits, monochrome and color images, video frames, as well as other data types.

In one aspect of the disclosed technology, a quantum-assisted machine learning framework is provided to implement a generative model to learn and sample the prior distribution of a GAN. In another aspect of the disclosed technology, a multi-basis technique is provided for measuring quantum states in different bases, hence enhancing the expression of the prior distribution. In another embodiment, the hybrid algorithm is trained on a trapped-ion quantum device to generate higher-quality images, which quantitatively outperforms classical generative adversarial networks trained on the MNIST dataset for handwritten digits.

Machine learning (ML) algorithms have significantly increased in importance and value due to the rapid progress in ML techniques and computational resources. However, even state-of-the-art algorithms face significant challenges in learning and generalizing from large volumes of unlabeled data. Quantum-enhanced algorithms for ML are effective for noisy intermediate-scale quantum (NISQ) devices, with the potential to surpass classical ML capabilities, particularly with generative models. The generative models are probabilistic models, aimed at capturing the most essential features of complex data and generating similar data by sampling from the trained model distribution.

In one embodiment, the algorithm is implemented with a Quantum Circuit Born Machine (QCBM), as will be described. In another aspect, a multi-basis technique for quantum circuit-based models provides the ML algorithm with quantum samples in different measurements bases. Commonly, sampling a generative model refers to generating instances of data that follow an encoded probability distribution. Classical models are usually limited to one basis, which is not the case with quantum models.

Other approaches to using quantum circuit born machines (QCBM) have been proposed using Restricted Boltzmann Machines (RBMs) to model the prior distributions. However, RBMs have been shown to be outperformed by comparable QCBMs in learning and sampling probability distributions constructed from real-world data.

Quantum Circuit Associative Adversarial Network (QC-AAN) is an algorithm framework combining capabilities of noisy intermediate-scale quantum (NISQ) devices with classical deep learning techniques to learn relevant full-scale datasets. The framework applies a Quantum Circuit Born Machine (QCBM) to model and re-parametrize the prior distribution of a Generative Adversarial Network (GAN).

Within the QC-AAN framework, the prior distribution is modelled by a QCBM that slowly follows changes in the latent space during training of the generator and discriminator in a smooth transition training protocol, while mitigating instabilities that we have observed in classical Associative Adversarial Networks (AAN).

Implementations of the present technology can generate higher-quality images and qualitatively outperform comparable classical GANs trained on the MNIST dataset for handwritten digits. These and other features and advantages of the present invention will be described or will become apparent to those of ordinary skill in the art, in view of the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention;

FIG. 4 is an illustrates the system and method of the present invention including a generative adversarial network (GAN) using a quantum component;

FIG. 5 is a block diagram showing the steps for training a GAN using a quantum component;

FIG. 6 illustrates the functionality of the quantum component in combination with the generative adversarial network (GAN);

FIG. 7 illustrates a comparison of classical MNIST data with higher-resolution handwritten digit generated with a quantum component and a generative adversarial network (GAN), showing inception scores;

FIG. 8 illustrates higher-resolution handwritten digits generated using a trapped ion quantum device utilizing 8-qubits with a generative adversarial network (GAN);

FIG. 9 illustrates the inception score vs. the number of epochs for the data shown in FIG. 8; and

FIG. 10 is a schematic illustration of the principal operational components of a trapped ion quantum device.

### DETAILED DESCRIPTION

### Overview

Aspects of the technology disclosed herein include a Quantum Circuit Associative Adversarial Network (QC-AAN), which is an algorithm framework combining capabilities of noisy intermediate-scale quantum (NISQ) devices with classical deep learning techniques to learn relevant full-scale datasets. The framework applies a Quantum Circuit Born Machine (QCBM) to model and re-parametrize the prior distribution of a Generative Adversarial Network (GAN).

Furthermore, the technology introduces a multi-basis technique for a quantum generative model that enhances deep generative algorithms by providing them with non-classical distributions and quantum samples from a variety of measurement bases. In one aspect, the QC-AAN may be implemented with 8-qubits or higher to generate the first handwritten digits with end-to-end training on a trapped ion quantum device.

In the last decades, machine learning (ML) algorithms have significantly increased in importance and value due to the rapid progress in ML techniques and computational resources. However, even state-of-the-art algorithms face significant challenges in learning and generalizing from an ever-increasing volume of unlabeled data. With the advent of quantum computing, quantum algorithms for ML arise as natural candidates in the search of applications of noisy intermediate-scale quantum (NISQ) devices, with the potential to surpass classical ML capabilities. Among the top candidates to achieve a quantum advantage in ML are generative models, i.e., probabilistic models aiming to capture the most essential features of complex data and to generate similar data by sampling from the trained model distribution.

There has been promising progress towards demonstrating a quantum supremacy for specific quantum computing tasks, and quantum generative models have been proven to learn distributions which are outside of classical reach. Still, it is not clear that enhancements provided by a generative quantum model are limited to cases where one can prove a theoretical gap between classical and quantum algorithms. In particular, quantum resources offer a divergent set of tools for addressing various challenges and could instead lead to a practical quantum advantage by avoiding pitfalls of conventional classical algorithms. For example, quantum resources can improve training and consequently enhance performance on generative tasks.

Despite all promises, applying and scaling quantum models on small quantum devices to address real-world datasets remains a significant challenge for quantum ML algorithms. Some approaches propose to enable quantum models for practical application by exploiting the known dimensionality reduction capabilities of deep neural networks, where classical data is compressed before it is passed for handling to a small quantum device. Having a quantum model learn the latent representation of data and participate in a joint quantum-classical training loop opens hybrid models to leverage quantum resources and potentially enhance performance when compared to purely classical algorithms.

This synergistic interaction between a quantum model and classical deep neural networks was central to the proposed quantum-assisted Helmholtz machine and more recent hybrid proposals for enhancing Associative Adversarial Networks (AAN). One proposal involved the use of a Quantum Boltzmann Machine (QBM), which was demonstrated with a D-Wave 2000Q annealing device. A similar adoption of this hybrid strategy with quantum annealers has been explored with variational autoencoders.

Despite these efforts, a definite demonstration using true quantum resources on NISQ devices and with full-size ML datasets (e.g., the MNIST dataset of handwritten digits) remained elusive. Recent experimental results on gate-based quantum computers illustrate that current proposals are far from generating higher-quality MNIST digits. Embodiments of the present invention overcome the shortcomings of prior approaches.

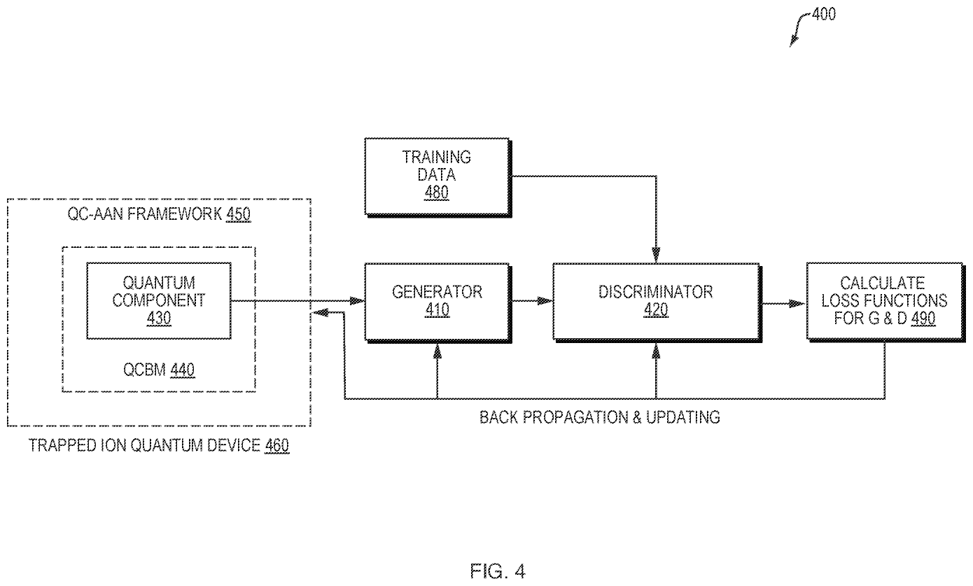

Turning to FIG. 4, an overview illustration of an embodiment of the present technology is shown. A quantum-enabled generative adversarial network (GAN) is generally shown as 400. The GAN includes a generator 410 and a discriminator 420. The input to the generator is from a quantum component 430, which is part of a Quantum Computer Born Machine (QCBM) implemented on a Quantum Circuit Associative Adversarial Network (QC-AAN). The quantum hardware implementing this configuration is a trapped ion quantum device 460, although other quantum hardware technologies and configurations may be used instead. Training data 480 is supplied to the discriminator, along with data synthesized by the generator 410. Embodiments of these elements and their interactions will be described in more detail in what follows.

The Generative Adversarial Network (GAN) 400 may create realistic datasets that are indistinguishable from true data as provided by the training data samples 480.

For training the GAN 400, a dataset such as the MNIST (Modified National Institute of Standards and Technology) database 480 may be used, which is a collection of thousands of handwritten digits used for training ML algorithms in supervised and also unsupervised deep learning applications. The MNIST database 480 is merely one example of a dataset that may be used to train the GAN 400. More generally, the dataset that is used to train the GAN 400 may include data other than data representing digits. For example, the dataset that is used to train the GAN 400 may include any one or more of the following, in any combination: handwritten digits, monochrome images, color images, and video frames.

The GAN 400 includes a generator 410 coupled with a discriminator 420, which form two competing neural networks. A GAN (such as the GAN 400) is often compared to a game between the two neural networks (i.e., the generator 410 and discriminator 420). Instances of real data 480, images for example, are input to the discriminator 420 along with instances of synthesized or fake data, provided by the generator 410. The discriminator 420 attempts to classify each instance as “real” or “fake,” and the discriminator 420 and generator 410 are updated accordingly, in turn. The database of training data 480 supplies real data instances to the discriminator 420.

Conventional GANs are fed random noise to produce a set of fake data points in the discriminator. Embodiments of the present invention, such as the GAN 400 of FIG. 4, may use a quantum component 430, operatively coupled to the generator 410 to provide an input, based on a prior function. The quantum component 430 accepts a sequence of instructions to evolve a quantum state based on a series of quantum gates. The discriminator 420 classifies the data from the two sources (i.e., the training data 480 and the generator 410) as real or fake. Two loss functions 490 are estimated. One loss function is estimated for the generator (to indicate the performance of the generator in producing data which is classified as real data) and another loss function is estimated for the discriminator (to indicate the performance of the discriminator in separating fake data from real data). The generator 410, the discriminator 420, and the quantum component 430 are updated so that the algorithm continues to improve over time, until the generator 410 produces exceedingly convincing samples which fool the discriminator 420. Embodiments of the present invention also include updating the quantum component 430. The update could depend directly on sampling the discriminator, based on values of weights in the discriminator, or based on a third loss function independent of the discriminator.

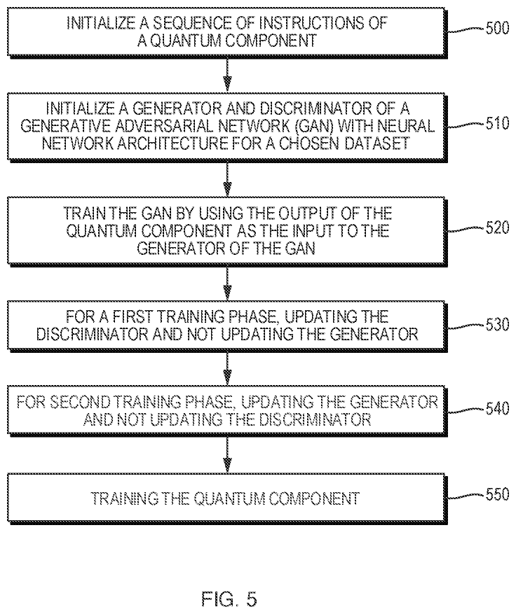

FIG. 5 is a block diagram showing the steps for training the GAN 400 using the quantum component 430. In step 500, the quantum component 430 is initialized with a sequence of instructions. In step 510, the generator 410 and discriminator 420 of the generative adversarial network (GAN) 400 are initialized. The neural network architecture of the generator 410 and the discriminator 420 is chosen to generate a particular dataset, such as handwritten digits or monochrome and color images or video frames, merely as examples. In step 520, the GAN 400 is trained by providing the output of the quantum component 430 as the input to the generator 410 of the GAN 400. In step 530, for a first training phase, the discriminator 420 is updated while not updating the generator 410. In step 540, for a second training phase, the generator 410 is updated while not updating the discriminator 420. The generator 410 and discriminator 420 may be trained using different processes (i.e., the generator 410 may be trained by a first process, and the discriminator 420 may be trained by a second process that differs from the first process). For example, the discriminator 420 may train for one or more epochs of the discriminator 420's training phase, and the generator 410 may train for one or more epochs of the generator 410's training phase. The generator 410 may be held constant during the discriminator 420's training phase. As the discriminator attempts to figure out how to distinguish real data from fake data, it may learn the generator 410's flaws. Similarly, the discriminator 420 may be held constant during the generator 410's training phase. Otherwise, the generator 410 would be trying to hit a shifting target and might never converge. This back and forth allows the GAN 400 to handle otherwise intractable generative problems. Finally, in step 550 the quantum component 430 is trained and updated. As stated, the quantum component 430 accepts a sequence of instructions to evolve a quantum state based on a series of quantum gates. The generator 410, the discriminator 420, and the quantum component 430 are updated through a long series of epochs, so that the algorithm continues to improve over time, and the generator 410 produces exceedingly convincing samples which fool the discriminator 420.

### The OC-AAN

The Quantum Circuit Associative Adversarial Network (QC-AAN) is a framework combining capabilities of NISQ devices with classical deep learning techniques to learn relevant full-scale datasets. The framework applies a Quantum Circuit Born Machine (QCBM) to model and re-parametrize the prior distribution of a Generative Adversarial Network (GAN). Furthermore, a multi-basis technique is provided for the QCBM. The use of a quantum generative model enhances deep generative algorithms by providing them with non-classical distributions and quantum samples from a variety of measurement bases.

The practical application of this QC-AAN framework has been implemented using 8-qubits to generate the first handwritten digits with end-to-end training on an ion-trap quantum device. (Embodiments of the QC-AAN framework may be implemented with 8 or more qubits.) The components of the QC-AAN in certain embodiments are discussed in what follows.

A QCBM is a circuit-based generative model which encodes a data distribution in a quantum state. This approach allows for sampling of the QCBM by repeatedly preparing and measuring its corresponding wavefunction

|Ψ(θ) [symbol] =U(θ)|0 [symbol] .

U(θ) is a parameterized quantum circuit acting on an initial qubit state |0 [symbol] , with U chosen according to the capabilities and limitations of NISQ devices. The probabilities for observing any of the 2n bitstrings Sᵢ in the n-bit (qubit) target probability distribution are modeled using the Born probabilities such that

P(Sᵢ)=| [symbol] Sᵢ|Ψ(θ) [symbol] |².

Importantly, QCBMs can be implemented on most NISQ devices, which opens the possibility of using the disclosed algorithm to exploit unique features of quantum circuit-based approaches, like the multi-basis technique of the present invention.

GANs are one of the most popular recent generative machine learning algorithms able to generate remarkably realistic images and other data. In a GAN, a generator G and a discriminator D are trained according to the adversarial min-max cost function

$${𝒞}_{GAN} = {min}_{G} {max}_{D} [ {𝔼}_{x \sim {p}_{data} ( x )} [ log D ( x ) ] + {𝔼}_{z \sim q ( z )} [ log ( 1 - D ( G ( z ) ) ) ] ] .$$

G learns to map prior samples z from the prior distribution q to good outputs G(z) while D attempts to identify whether input data is from the training data P data or if it was generated by G. The prior of G is conventionally a high-dimensional continuous uniform or normal distribution with zero mean, although discrete Bernoulli priors have also been shown empirically to be competitive. For a given learning task, the prior distribution should generally be of a shape that allows G to effectively map it to a high-quality output space while still providing enough edge cases for the model to explore the entire target data space. A small prior could potentially lead to the algorithm not learning a good approximation of the target data, whereas a large prior requires a notably expressive neural network architecture to be able to map the full space to high-quality outputs. Consequently, ML practitioners often rely on sufficiently large priors and scale the number of parameters in the GAN for their purpose. Other common challenges in training a GAN lie in mode-collapse and non-convergence, which are natural consequences of the delicately balanced adversarial game.

The Associative Adversarial Networks (AAN) address all of these challenges by implementing a nontrivial prior distribution for the generator G. In an AAN, the prior distribution of G is reparametrized by a smaller generative model. The latter is trained on activations z in layer 1 of D, which constitute the latent representation of input data. As such, the latent space captures features of the training data and generated data which the discriminator D deems to be important for its classification task. To that end, the GAN cost function in the next equation is extended with the likelihood distance

$${𝒞}_{q} = {max}_{q} {\dot{z} \sim {p}_{l} ( \hat{z} )}_{} [ log q ( \hat{z} ) ]$$

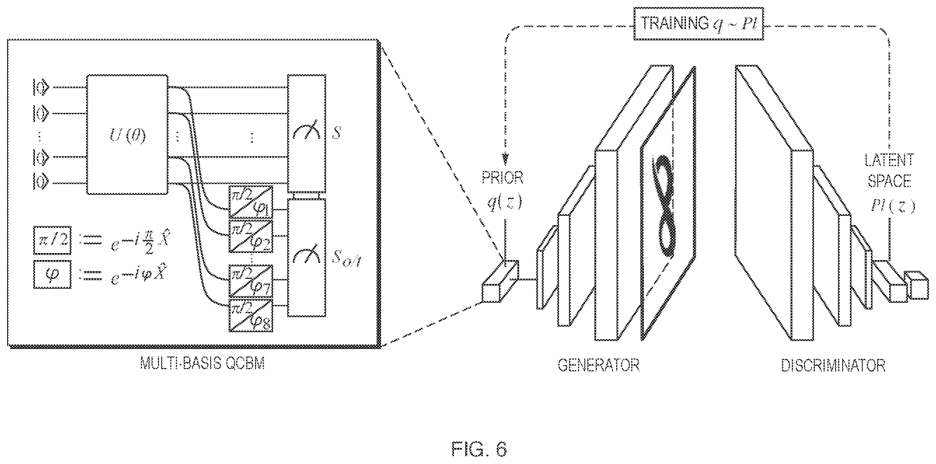

between the current prior distribution q and the latent space distribution pi. This introduces a structure into the prior q which is specific to the training dataset and the current stage of training. A schematic overview of this algorithm can be viewed in FIG. 6.

Although the original Associative Adversarial Networks (AAN) work proposed using Restricted Boltzmann Machines (RBMs) to model the prior, RBMs have been shown to be outperformed by comparable QCBMs in learning and sampling probability distributions constructed from real-world data. In the disclosed QC-AAN algorithm, the prior is modelled by a QCBM that slowly follows changes in the latent space during training of the generator and discriminator in a smooth transition training protocol, mitigating instabilities that we have observed in classical Associative Adversarial Networks (AAN).

The present technology takes advantage of an exclusive property of quantum generative models, i.e., their representation of encoded probability distributions in different bases. By training a QCBM on computational basis samples, families of sample distributions, i.e., projections of the wavefunction, become accessible in a range of other basis sets without adding a large number of parameters in the quantum circuit. The present multi-basis technique for the QCBM provides the QC-AAN with a prior space consisting of quantum samples in flexible bases, potentially enhancing the overall performance of the generator.

FIG. 6 illustrates how a second set of measurements is prepared in the multi-basis technique by applying parametrized post-rotations to the QCBM wavefunction. Samples of both bases are forwarded through a fully-connected neural network layer and into the generator to learn an effective use of all measurements. The second measurement basis in the multi-basis QCBM can be fixed, for example, to measure all qubits in the orthogonal Y-basis, or it can be trained for each qubit along with other circuit parameters to optimize the information extracted from the quantum state. These variants are called QC₊₀₋AAN and QC₊ₜ₋AAN, respectively.

As a first step towards showcasing the QC-AAN and the multi-basis technique, embodiments of the technology disclosed herein may numerically simulate training on the canonical MNIST dataset of handwritten digits, a standard dataset for benchmarking a variety of ML and deep learning algorithms, using (merely as an example) the Orquestra™ platform of Zapata Computing. To isolate the effect of modelling the prior with a QCBM, a comparison is made to compare quantum-classical models to purely classical Deep Convolutional GANs (DCGANs) with precisely the same neural network architecture and with uniform prior distribution.

The QCBM is initiated with a warm start such that the prior distribution is uniform and thus QC-AANs and DCGANs are equivalent at the beginning of training. This initialization additionally avoids complications related to barren plateaus.

To quantitatively assess performance, we calculate the Inception Score (IS). The inception score evaluates the quality and diversity of generated images in GANs. The Inception Score is high for a model which produces very diverse images of higher-quality handwritten digits.

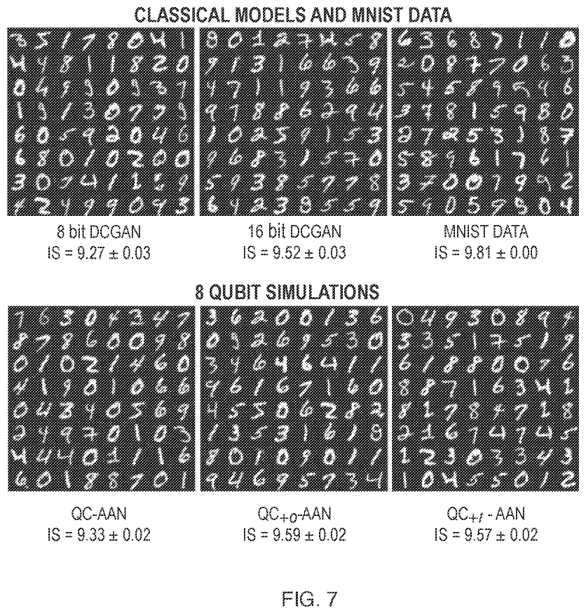

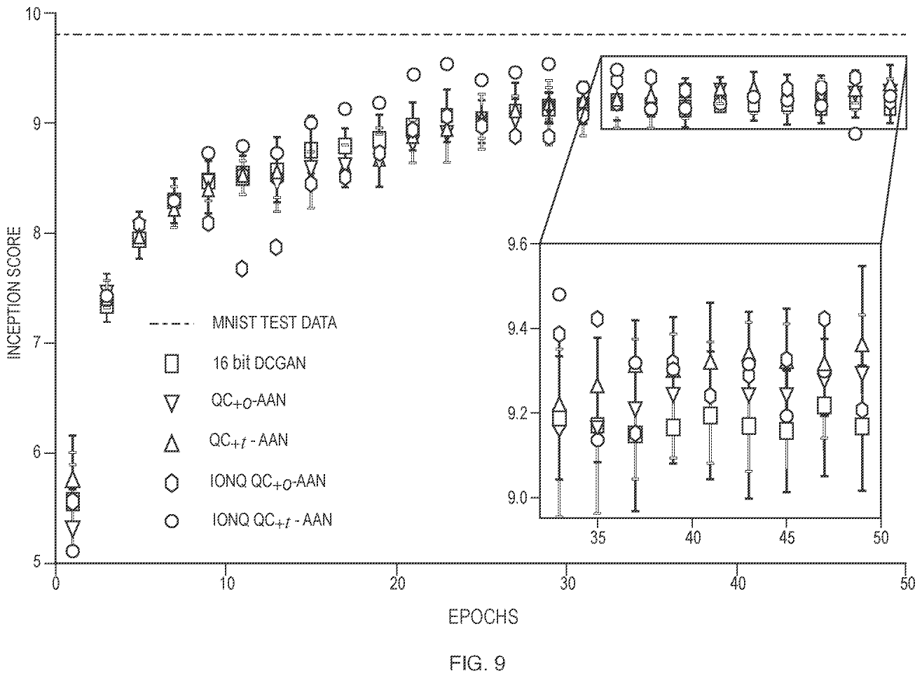

FIGS. 7-9 show results of handwritten digits generated by the present models. For each model type, the best-performing models are shown in terms of the Inception Score (IS) in FIG. 9, which is chosen based on quality and diversity of the images for a human observer. The generated digits themselves are random subsamples of the selected models. It is apparent that all models presented here can achieve good performance and output higher-resolution handwritten digits. In a quantitative evaluation of average model performance, we see that the 8-qubit QC-AAN without multi-basis technique typically does not outperform comparable 8-bit DCGANs under any of the hyperparameters explored.

For low-dimensional priors in general, a uniform prior distribution seems to yield optimal training for the GANs. In contrast, both multi-basis QC-AAN models (the QC₊₀₋AAN and the QC₊ₜ₋AAN) generate visibly better images and achieve higher Inception Scores than the 8-bit and 8-qubit models without additional basis samples. FIGS. 7-9 show that, with an average Inception Score of 9:28 and 9:36, respectively, both multi-basis models outperform the 16-bit DCGAN with an average IS of 9:20. This remarkable result suggests that an 8-qubit multi-basis QCBM does not require full access to a 16-qubit Hilbert space to outperform a 16-bit DCGAN. Another key observation is that the trained-basis approach generally enhances the algorithm even more, compared to the fixed orthogonal-basis approach.

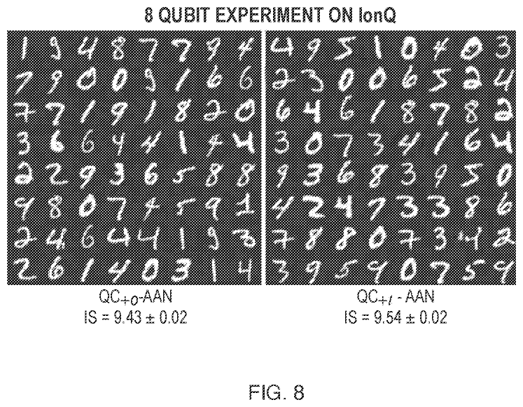

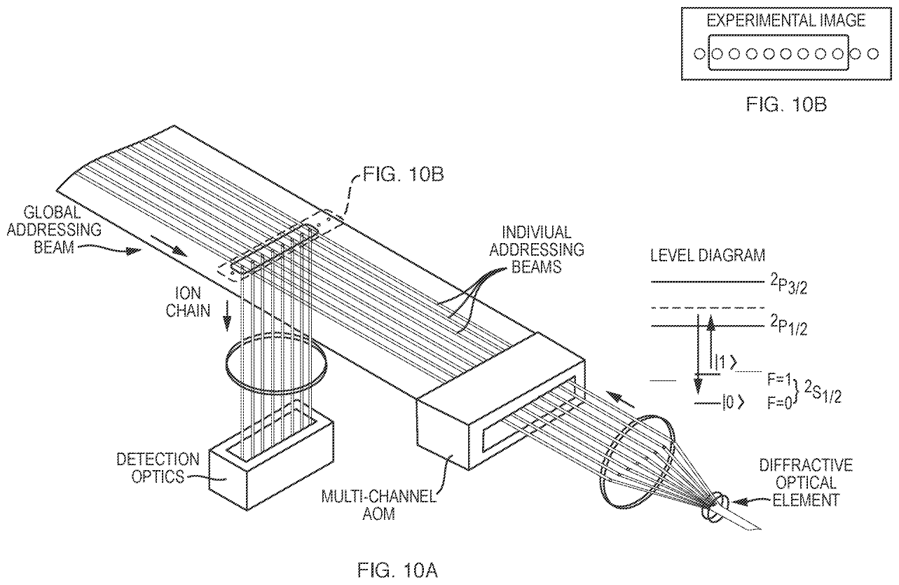

FIG. 10 provides a confirmation that the QC-AAN framework is suitable for implementation on NISQ devices. Training was performed on both QC_{+o/t-}AAN algorithms on a trapped ion quantum device from IonQ Corporation, which is based on 171Yb+ ion qubits. This structure of this device is generally illustrated in FIG. 10. The experimental results for the training on hardware can be viewed in FIG. 8. This is believed to be the first practical implementation of a quantum-classical algorithm capable of generating higher-resolution digits on a NISQ device.

With as few as 8-qubits, we show signs of positively influencing the training of GANs and indicate general utility in modelling their prior with a multi-basis QCBM on NISQ devices. Learning the choice of the measurement bases through the quantum-classical training loop, i.e., our QC₊ₜ₋AAN algorithm, appears to be the most successful approach in simulations and also in the experimental realization on the IonQ device.

Quantum components in a hybrid quantum ML algorithm are capable of effectively utilizing feedback coming from classical neural networks. and a testament to the general ML approach of learning the best parameters rather than fixing them. It is reasonable that significant re-parametrization of the prior space, paired with a modest noise floor, provide GANs with an improved trade-off between exploration of the target space and convergence to higher-quality data.

The disclosed QC-AAN framework also extends flexibly to more complex datasets such as data with higher resolution and color (monochrome and color image data, and also video frames), for which refinement of the prior distribution becomes more vital for performance of the algorithm.

The disclosed technology disclosed can be practiced as a system, method, device, product, computer readable media, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections. These recitations are hereby incorporated forward by reference into each of the following implementations.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿ×2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

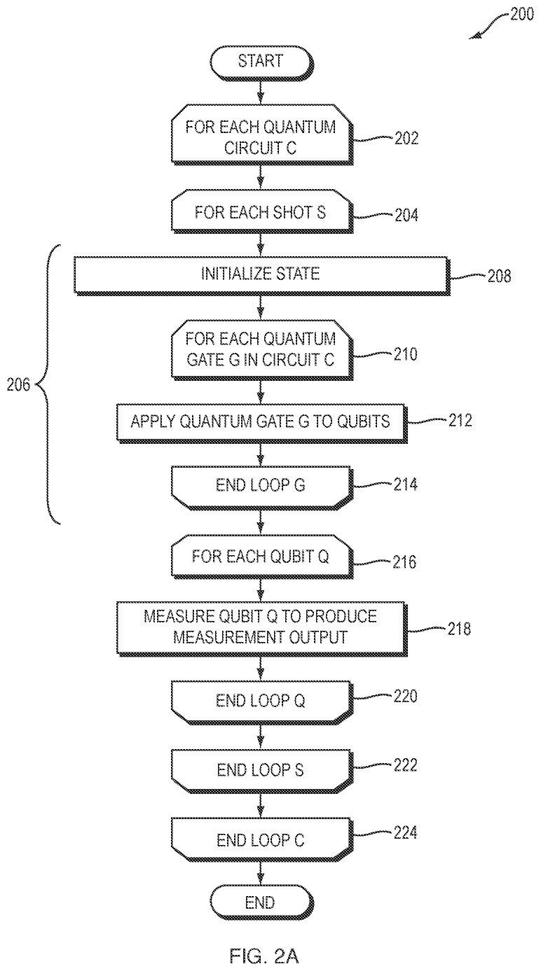

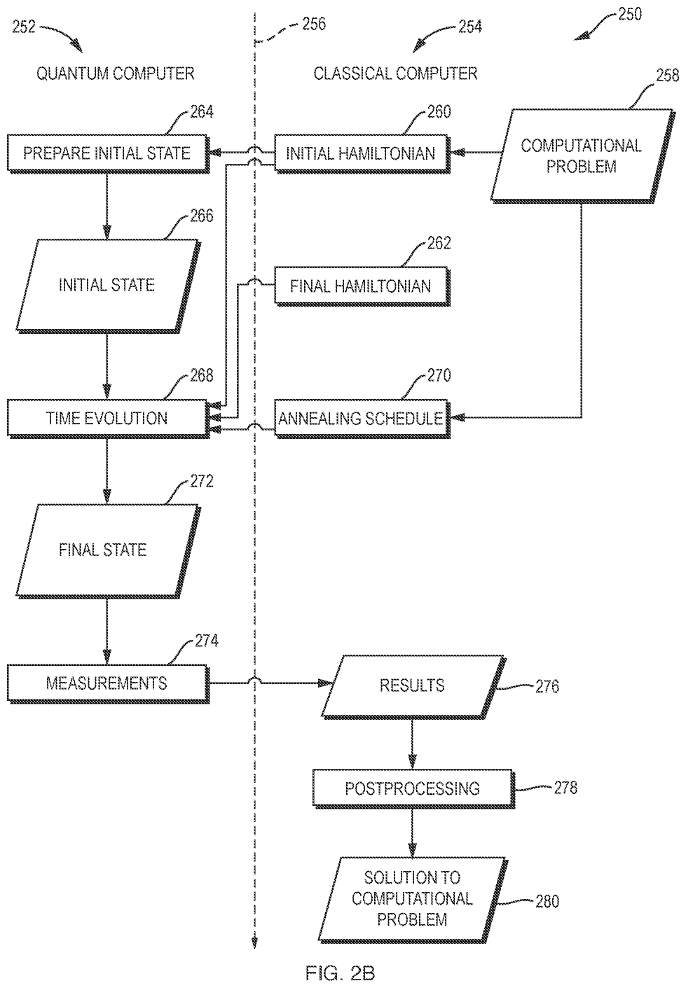

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

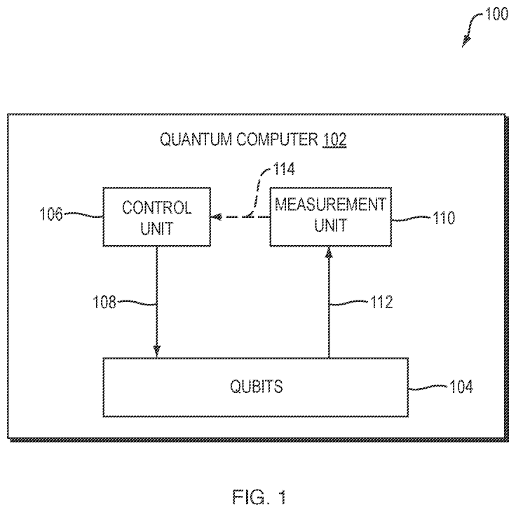

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

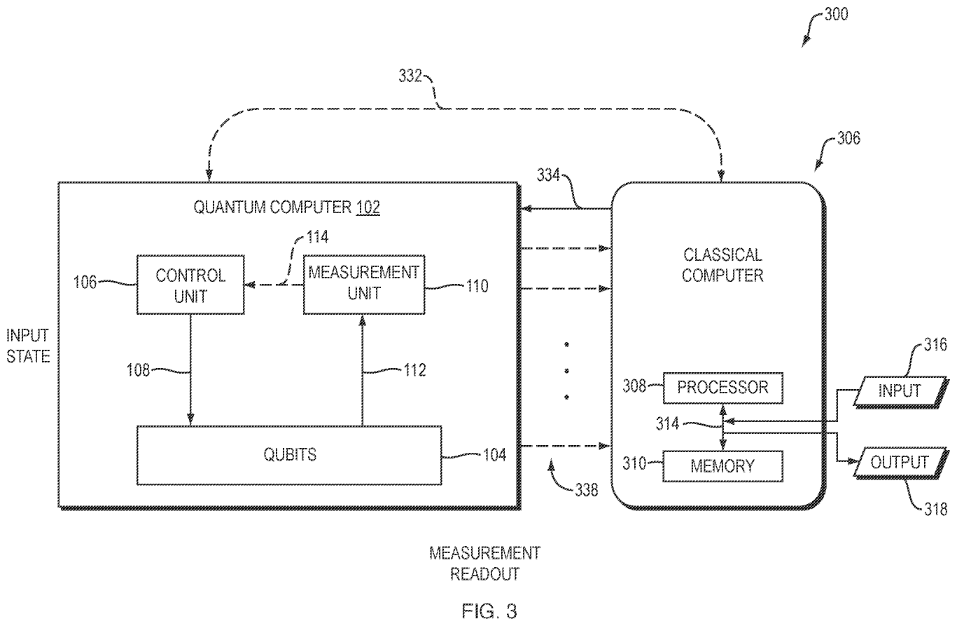

Referring to FIG. 3, a diagram is shown of a hybrid quantum classical computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention train and apply artificial neural networks to generate realistic images of handwritten digits. Such a function cannot be performed mentally or manually by a human.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A hybrid quantum-classical computer system for generating a dataset, comprising:
a quantum computer comprising a plurality of qubits;
a classical computer including a processor, a non-transitory computer-readable medium, and computer instructions stored in the non-transitory computer-readable medium;
a generator and a discriminator operatively coupled to each other to function as a generative adversarial network (GAN) with neural network architectures for a given dataset, the discriminator having a latent space; and
a quantum component, operatively coupled to the generator to provide an input to the generator, which accepts a sequence of instructions to evolve a quantum state based on a series of quantum gates;
wherein the computer instructions, when executed by the processor, perform a method for generating, on the hybrid quantum-classical computer, a dataset having a plurality of datapoints, the method comprising:
initializing the sequence of instructions of the quantum component;
initializing the generator and the discriminator of the generative adversarial network (GAN); and
training the GAN using the output of the quantum component as an input to the generator of the GAN, wherein the training occurs iteratively in a first phase and a second phase,
wherein, in the first phase, the generator is not updated and the discriminator is updated;
wherein, in the second phase, the discriminator is not updated and the generator is updated.

2. The system of claim 1, wherein training the GAN further comprises training the quantum component.

3. The system of claim 2, wherein training the quantum component comprises training the quantum component based on a cost function.

4. The system of claim 2, wherein training the quantum component comprises utilizing the latent space of the discriminator.

5. The system of claim 1, wherein the latent space contains a layer of neurons equal in number to the size of the input of the generator.

6. The system of claim 1, wherein initializing the sequence of instructions of the quantum component comprises evolving the quantum state such that measurements of the quantum state output samples from a desired probability distribution.

7. The system of claim 4, wherein the desired probability distribution is uniform over a selected range.

8. The system of claim 1, wherein the quantum component is a quantum circuit born machine (QCBM).

9. The system of claim 1, further comprising measuring the quantum component using a multi-basis method.

10. The system of claim 1, wherein the quantum component comprises a trapped-ion quantum device.

11. The system of claim 5, wherein training the quantum component further comprises the measuring a loss function for the quantum component explicitly measured.

12. The system of claim 1, wherein the dataset includes higher-resolution handwritten digits.

13. The system of claim 1, wherein the dataset includes monochrome images and color images.

14. The system of claim 1, wherein the dataset includes video frames.

15. The system of claim 1, wherein the plurality of qubits includes at least 8-qubits.

16. A method, performed by a hybrid quantum-classical computer system, for generating a dataset, the hybrid quantum-classical computer system comprising:
a quantum computer comprising a plurality of qubits; and
a classical computer including a processor, a non-transitory computer-readable medium, and computer instructions stored in the non-transitory computer-readable medium;
a generator and a discriminator operatively coupled to each other to function as a generative adversarial network (GAN) with neural network architectures for a given dataset; and
a quantum component, operatively coupled to the generator to provide an input to the generator, which accepts a sequence of instructions to evolve a quantum state based on a series of quantum gates;
the method comprising:
initializing the sequence of instructions of the quantum component;
initializing the generator and the discriminator of the generative adversarial network (GAN); and
training the GAN using the output of the quantum component as an input to the generator of the GAN, wherein the training occurs iteratively in a first phase and a second phase,
wherein, in the first phase, the generator is not updated and the discriminator is updated;
wherein, in the second phase, the discriminator is not updated and the generator is updated.

17. The method of claim system of 16, wherein training the GAN further comprises training the quantum component.

18. The system of claim 17, wherein training the quantum component comprises training the quantum component based on a cost function.

19. The method of claim 16, wherein the quantum component is a quantum circuit born machine (QCBM).

20. The method of claim 19, wherein the initialization for the quantum circuit born machine (QCBM) uses a multi-basis method.

21. The method of claim 16, wherein the quantum component is a trapped-ion quantum device.

22. The method of claim 16, wherein a QC-AAN framework is used for the quantum component.

23. The method of claim 16, wherein the dataset includes higher-resolution handwritten digits.

24. The method of claim 16, wherein the dataset includes monochrome or color images.

25. The method of claim 16, wherein the dataset includes video frames.

26. The method of claim 16, wherein the encoded distribution is uniform over a selected range.

27. The method of claim 16, wherein the quantum component is a noisy intermediate-scale (NISQ) device.

28. The method of claim 16, wherein the latent space is increased in the discriminator and wherein the method further comprises training the samples of the multi-basis QCBM on its activations.
